(19) United States
(12) Patent Application Publication
(10) Pub. No.: US 2009/0146597 A1
(43) Pub. Date: Jun. 11, 2009

(54) METHOD FOR DETECTING THE POSITION OF A ROTOR

(76) Inventor: Volker Bosch, Echterdingen (DE)

Correspondence Address: MICHAEL J. STRIKER, 103 EAST NECK ROAD, HUNTINGTON, NY, 11743, US

(21) Appl. No.: 11/719,491

(22) PCT Filed: Jan. 3, 2006
(86) PCT No.: PCT/EP2006/050017

§ 371 Date: May 16, 2007

(30) Foreign Application Priority Data
Feb. 22, 2005 (DE) 102005007995.4

(51) Int. Cl. H02P 6/18

(52) U.S. Cl. 318/400.33

(57) ABSTRACT

The invention relates to a method for determining the position of a rotor (11) of an electric motor (9) comprising several stator blocks, in particular an EC motor (10), whereby several magnetic axes (d, q) are assigned to said rotor. According to the invention, a voltage is applied alternately to the stator blocks (U, V, W), the resultant currents are measured and an assignment of at least one stator block (U, V, W) to at least one magnetic axis (d, q) is determined. The invention also relates to a corresponding device (1).

The present invention relates to a method for detecting the position of a rotor of an electrical machine that includes several stator blocks, according to the preamble of claim 1, and a device for detecting the position of a rotor of an electrical machine according to the preamble of claim 13.

### RELATED ART

Numerous methods for detecting the position of a rotor of an electrical machine are known. There is a great deal of interest in the application of sensorless detection of rotor position in electronically commutated motors, i.e., EC motors and brushless DC motors. For small EC motors manufactured in large quantities, in particular, it is especially important to provide methods that are economical yet powerful, in order to combine cost-favorable manufacture with sufficient accuracy in the detection of rotor position. If the absolute rotor position is known with sufficient accuracy, current can be supplied to the stator blocks in a manner such that the motor starts up with maximum torque. It can then also be ensured that the motor starts up in the desired direction of rotation. According to the related art, methods that are easy and cost-favorable to realize typically do not begin to function reliably until the rotor is already rotating, since these methods are based on evaluating a current that is induced via rotation. (For an overview of current methods, reference is made to the publication “Xie, J.: Entwicklung eines Scherwellengenerators für den Einsatz in tiefen Bohrlöchern (Development of a Shear Wave Alternator for Use in Deep Boreholes”, VDI-Verlag, Düsseldorf, 1993”). Methods are also known which are capable of detecting the absolute position of the rotor at a standstill, but implementing these methods typically requires highly complex circuitry and results in high manufacturing costs.

### ADVANTAGES OF THE INVENTION

For a method for detecting the position of a rotor of an electrical machine composed of several stator blocks, of an EC motor in particular, in the case of which several magnetic axes with different magnetic conductances are assigned to the rotor, it is provided according to the present invention for a voltage to be applied alternately to the stator blocks, to measure the currents produced, and to determine an assignment of at least one stator block to at least one magnetic axis by evaluating the measured currents. This method is based on the finding that the current produced via voltage stimulation depends on the magnetic linkage between a magnetic axis of the rotor and a stator block. When a voltage is applied alternately to the stator blocks, different currents are therefore produced in each of the stator blocks, depending on how the particular stator block is oriented with respect to the rotor and its magnetic axis.

Advantageously, the stator blocks are controlled with changing polarity. The occurrence of a resultant torque can therefore be reduced or prevented, and the motor can be prevented from starting to rotate, particularly with a level of torque that is not negligible.

Preferably, the stator blocks are controlled with repeatedly changing polarity. A quasi-stationary state therefore results, albeit for a very short period of time, during which the current can be measured using simple means. This makes it possible to implement the method in a cost-favorable manner. It is also basically possible, of course, to measure the current flow with rapid measuring devices, without repeatedly changing the polarity.

It is advantageous when the evaluation includes the determination of the greatest amount of current measured. This makes it possible to easily deduce the greatest magnetic linkage.

According to a refinement of the present invention, the assignment of a stator block to the magnetic d axis of the rotor is determined. The stator block through which the highest current flows when stimulated has the greatest magnetic linkage with the d axis. This results in a simple method of making the assignment.

The voltage is advantageously applied in a pulse-width modulated manner. This makes it possible to reduce the voltage that acts effectively on the stator block, given a supply voltage that is assumed to be constant.

The current is advantageously measured using at least one shunt resistor located in a total current branch in particular.

With a preferred embodiment, a voltage is applied to the stator blocks, and at least one saturation effect of a current through a stator block is detected via a current measurement, in order to determine the magnetic orientation of the rotor. Once the assignment between a stator block and a magnetic axis of the rotor has been determined—and particularly with regard for the stator block to which the d axis is assigned—a voltage is applied again to this stator block. The control is chosen such that a saturation effect can become established in the stator block, which is reflected by a decrease in inductance and a faster current increase. This is the case when the equivalent magnetomotive force of the rotor magnets and the magnetomotive force of the energized stator block are superimposed with matching orientation. In the opposite case, i.e., when the magnetomotive forces are superimposed with opposite orientation, the current flow is less, thereby making it possible to distinguish between the same and opposed orientation of the rotor.

The saturation is preferably determined by measuring a voltage difference between a common star point of the stator blocks and a summing point formed at the inputs of the stator blocks. It is therefore possible to deduce the orientation of the rotor by evaluating the signal characteristic.

Advantageously, an integrated signal is generated from the voltage difference via integration over time.

Advantageously, the shape of the curve of the integrated signal is evaluated. The signal is a nearly triangular, provided the stimulation is essentially square-wave. The shape of this signal is used to determine the orientation of the rotor.

With a preferred refinement of the present invention, the integrated signal is investigated to detect a flattening and/or an excessively high section. The integrated signal differs from an idealized shape due to the saturation effects. In terms of the nearly triangular signal mentioned above, this means that one of the two peaks is flattened, while the other peak is excessively high. Depending on whether this flattening or excessively high section occurs on the lower peak or the upper peak of the triangular signal, the orientation of the rotor is either the same or opposed.

The present invention also relates to a device for detecting the position of a rotor of an electrical machine composed of several stator blocks, of an EC motor in particular, in the case of which several magnetic axes are assigned to the rotor, with a control device that applies voltage alternately to the stator blocks, a current measuring device that measures the currents produced, and an evaluation device that determines an assignment of at least one stator block to at least one magnetic axis based on the measured currents.

### DRAWING

The present invention will now be explained in greater detail with reference to exemplary embodiments.

FIG. 1 is an exemplary embodiment of a device for detecting the position of a rotor of an electrical machine, and

FIG. 2 is an exemplary embodiment of a four-pole rotor and its magnetic axes.

### DESCRIPTION OF THE EXEMPLARY EMBODIMENTS

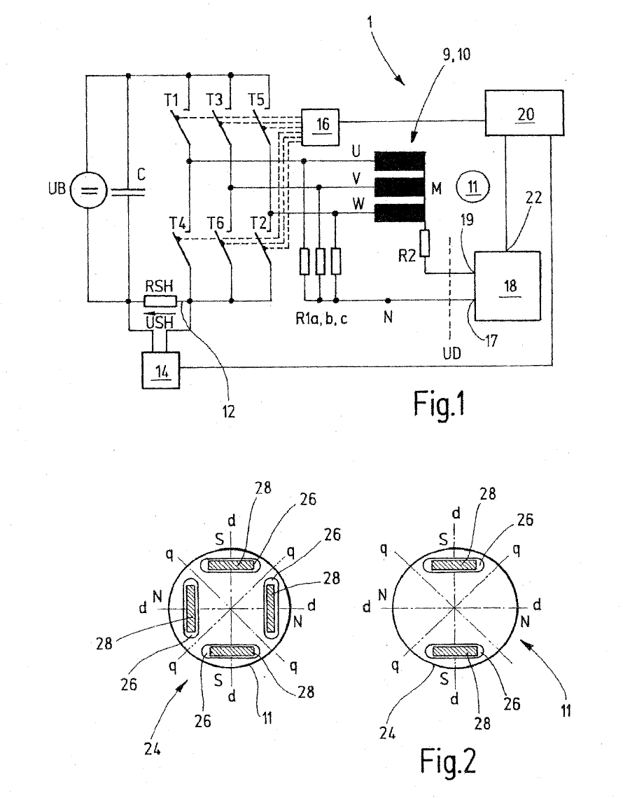

FIG. 1 shows an advantageous embodiment of a device 1, based on which the inventive method will now be described as an example. An electrical machine 9, an EC motor 10 in this case, with stator blocks U, V, W, a star point M and a rotor 11 are depicted symbolically, and transistors T1 through T6 for realizing a bridge connection are shown. EC motor 10 can be supplied via a direct-current source UB with parallel-connected capacitor C. A shunt resistor RSH is located in summation current branch 12, across which voltage USH drops. Voltage USH is translated into a current value by current measuring device 14. Transistors T1 through T6 are controlled by a control device 16, as illustrated using the dashed lines that lead out of control device 16. A summing point N is formed at the inputs of stator blocks U, V, W via resistors R1a, R1b, R1c, the potential of which is sent to a first input 17 of an integrator 18. The potential of star point M is sent to a second input 19 of integrator 18 via a resistor R2. The dashed line indicates that a voltage difference UD is effectively supplied to integrator 18. Outlet 22 of integrator 18 is connected with an evaluation device 20, to which current measuring device 14 and control device 16 are also connected. In order to detect the rotor position, two steps are now carried out, in this embodiment: In a first step, it is determined which stator block U, V, W corresponds to the magnetic d axis of rotor 11. In a second step, the orientation of rotor 11 relative to stator block U, V, W that was just determined is detected. These two steps will now be explained.

In order to determine which stator block U, V, W is magnetically coupled with the magnetic d axis of rotor 11, positive current is supplied to stator block U. To do this, transistors T1, T2, T6 are closed. After half of a specified cycle time has passed, negative current is supplied to stator block U, i.e, transistors T1, T2, T6 are opened, and transistors T3, T4, T5 are closed. The resultant current can now be measured using current measuring device 14 or, as an alternative, the cycle described above can be repeated a few times in order to measure current in a quasi-stationary state. The selected cycle time must not be too short, or eddy currents in the core will corrupt the measurement. Nor should the selected cycle time be too long, or the current will continue to rise with every half-wave. As an alternative to this cycle, pulse-width modulated control can be carried out. To do this, positive current is supplied to stator block U for the first half of the cycle for a first time section, e.g., 60% of the duration of half of a cycle, then negative current is supplied for the time remaining in the cycle half (second time section), e.g., 40%. During the second half of the cycle, positive current is supplied to stator block U for the duration of the second time section, i.e., 40% of the duration of the cycle half, then negative current is supplied for the time remaining in the cycle half, e.g., 60% of the duration of a cycle half in this example. As a result, the voltage that is effectively present at stator block U is reduced.

Independent of the type of stimulation selected, the current measurements are also carried out for the remaining stator blocks V, W. With these values, it is possible to determine with which of the three stator blocks U, V, W the d axis of rotor 11 is magnetically linked: Stator block U, V, W through which the highest current flows when stimulated has the greatest magnetic linkage with the d axis. For the discussions below, it is assumed that stator block U was determined to be linked with the d axis.

Now the second step takes place, in which a check is carried out to determine whether rotor 11 is linked with stator block U in north-south orientation or south-north orientation. To do this, the stimulation signal described is applied once more to previously-identified stator block U. Since—as described in the general part of the description—the aim is to attain a saturation effect, a greater amount of current is typically selected than in the first step. If pulse-width modulated control was selected, the current increase or basic voltage increase can be adjusted by changing the on/off ratio: For example, in the first half of the cycle, an on/off time of 80% to 20% can be set, and an on/off time of 20% to 80% can be set in the second half of the cycle. (Of course, the simple control, i.e., positive current supplied in the first half of the cycle and negative current supplied in the second half of the cycle, can be selected, if necessary.) As mentioned above, there is a voltage difference UD between summing point N and the potential of star point M supplied across resistor R2. Since the signal of voltage difference UD can contain interferences, particularly when pulse-width modulated control is used, it is advantageous to smooth the signal of the voltage difference UD. In this case, a connected operational amplifier was used as integrator 18, but many alternatives are feasible, of course, including an RC low pass in particular. If the stimulation signal mentioned above is present at stator block U, a nearly triangular signal can be observed at output 22 of integrator 18. Since, in this case, the d axis of rotor 11 corresponds to the axis of stimulated stator block U, saturation effects in the magnetic circuits of EC motor 10 can be detected starting at a certain value of the stator current. (To attain this saturation effect, the current must be sufficiently high, as mentioned). With certain designs of device 1 and EC motor 10, this results, e.g., in the integrator signal becoming asymmetrical and one of the two peaks in the nearly triangular signal flattening. With other designs, the effect can manifest itself differently, but it is always possible to identify the orientation of rotor 11. This can take place, e.g., via analog-digital conversion and evaluation in evaluation unit 20. As a result, the rotor position is known with sufficient accuracy such that it is possible to start EC motor 10 rotating exactly as intended.

FIG. 2 shows, in the illustration on the left, as an example, a four-pole rotor 11 with a mechanically symmetrical design. Rotor 11 includes a core 24 with four recesses 26.

Magnet disks 28 are inserted in each recess 26. Magnetic axes d, q of rotor 11 are labeled d (d axis) and q (q axis). FIG. 2 shows, in the illustration on the left, a four-pole rotor 11 with a mechanically asymmetrical design. Magnetic axes d, q of rotor 11 are also shown in this illustration. The d axis “d” has reduced magnetic conductance, and q axis “q” has increased magnetic conductance.

The inventive method can be realized in a particularly cost-favorable manner. All the more so, because it is easily combined with other methods. These include methods that are described, e.g, in “Reutlinger, Kurt: Mechatroniksystem für Einzelspindelantriebe in Textilmaschinen (Mechatronics System for Single-Spindle Drives in Textile Machines), Shaker-Verlag, Aachen, 1997” and in “Bosch, Volker: Elektronisch kommutiertes Einzelspindelantriebssystem (Electronically Commutated Single-Spindle Drive System), Shaker-Verlag, Aachen, 2001”.

What is claimed is:

1. A method for detecting the position of a rotor (11) of an electrical machine (9) composed of several stator blocks (U, V, W), of an EC motor in particular (10); several magnetic axes (d, q) with different magnetic conductances are assigned to rotor (11), wherein
a voltage is applied alternately to the stator blocks (U, V, W), the currents produced are measured, and an assignment of at least one stator block (U, V, W) to at least one magnetic axis (d, q) is determined by evaluating the measured currents.

2. The method as recited in claim 1, wherein
the stator blocks (U, V, W) are controlled with changing polarity.

3. The method as recited in claim 1, wherein
the stator blocks (U, V, W) are controlled with repeatedly changing polarity.

4. The method as recited in claim 1, wherein
the evaluation includes the determination of the highest measured current.

5. The method as recited in claim 1, wherein
the assignment of a stator block (U, V, W) to the magnetic d axis (d) of the rotor (11) is determined.

6. The method as recited in claim 1, wherein
the voltage is applied in a pulse-width modulated manner.

7. The method as recited in claim 1, wherein
the current is measured using at least one shunt resistor (RHS) located in a summing current branch (12) in particular.

8. The method as recited in claim 1, wherein
a voltage is applied to the stator blocks (U, V, W), and, using a current measurement, at least one saturation effect of a current through a stator block (U, V, W) is determined for detecting the magnetic orientation of the rotor (11).

9. The method as recited in claim 8, wherein
the saturation is determined by measuring a voltage difference (UD) between a common star point (M) of the stator blocks (U, V, W) and a summing point (N) formed at the inputs of the stator blocks (U, V, W).

10. The method as recited in claim 9, wherein
an integrated signal is generated from the voltage difference (UD) via integration over time.

11. The method as recited in claim 10, wherein
the integrated signal is evaluated with regard for its curve shape.

12. The method as recited in claim 10, wherein
the integrated signal is investigated to detect a flattening and/or an excessively high section.

13. A device (1) for detecting the position of a rotor (11) of an electrical machine (9) composed of several stator blocks (U, V, W), of an EC motor in particular (10); several magnetic axes (d, q) with different magnetic conductances are assigned to rotor (11), characterized by
a control device (16) that applies voltage alternately to the stator blocks (U, V, W), a current measuring device (14) that measures the currents produced, and an evaluation device (20) that determines—based on the currents measured—an assignment of at least one stator block (U, V, W) to at least one magnetic axis (d, q).
